(19) United States
(12) Patent Application Publication
(10) Pub. No.: US 2019/0023184 A1
(43) Pub. Date: Jan. 24, 2019

(54) SIDE MIRROR ASSEMBLY WITH INTEGRATED SPOTTER MIRROR

(71) Applicant: Ficosa North America Corporation, Madison Heights, MI (US)

(72) Inventors: Sergio Hellin Navarro, Madison Heights, MI (US); Vijay Thota, Madison Heights, MI (US); Ricardo Peña Garza, Madison Heights, MI (US); Nicholas Schmidt, Madison Heights, MI (US)

(73) Assignee: Ficosa North America Corporation, Madison Heights, MI (US)

(21) Appl. No.: 16/004,291

(22) Filed: Jun. 8, 2018

Related U.S. Application Data
(60) Provisional application No. 62/536,332, filed on Jul. 24, 2017.

(51) Int. Cl. B60R 1/12; B60R 1/06

(52) U.S. Cl. CPC B60R 1/12; B60R 2001/1238; B60R 1/06

(57) ABSTRACT

A side mirror assembly for a vehicle includes a housing defining an interior volume and a mirror aperture, primary and secondary mirrors coupled to the housing and extending across the mirror aperture, and a support coupled to the housing and at least one of the primary mirror and the secondary mirror. The primary mirror has a first outer surface, and the secondary mirror has a second outer surface. The primary mirror and the secondary mirror are reflective and provide different fields of view. The primary mirror and the secondary mirror are arranged such that the primary mirror is at least partially superimposed on the secondary mirror, thereby defining an overlapped area of the second outer surface. A visible reflective area of the first outer surface is a larger than a visible reflective area of the second outer surface.

### CROSS-REFERENCE TO RELATED PATENT APPLICATION

This application claims the benefit of U.S. Provisional Patent Application No. 62/536,332, filed Jul. 24, 2017, which is incorporated herein by reference in its entirety.

### FIELD

Embodiments of the present disclosure relate to a side mirror assembly for a vehicle that includes a spotter mirror and a method of making and using the same.

### BACKGROUND

Many vehicles utilize external mirrors to assist a driver in monitoring an area along the side of or behind the vehicle. In some cases, the external mirrors include both a primary mirror and an additional secondary spotter mirror that expands the area shown to the driver by the external mirror.

### SUMMARY

Systems, methods, and apparatuses for a side mirror of a vehicle are shown and described. In one embodiment, a side mirror assembly for a vehicle includes a housing configured to be coupled to the vehicle and defining both an interior volume and a mirror aperture, a primary mirror coupled to the housing and extending at least partially across the mirror aperture, a secondary mirror coupled to the housing and extending at least partially across the mirror aperture, and a support coupled to the housing and at least one of the primary mirror and the secondary mirror. The primary mirror has a first inner surface facing towards the interior volume and a first outer surface opposite the first inner surface. The primary mirror is reflective and provides a first field of view. The secondary mirror has a second inner surface facing towards the interior volume and a second outer surface opposite the second inner surface. The secondary mirror is reflective and provides a second field of view different from the first field of view. The primary mirror and the secondary mirror are arranged such that the primary mirror is at least partially superimposed on the secondary mirror, thereby defining an overlapped area of the second outer surface. A visible reflective area of the first outer surface is a larger than a visible reflective area of the second outer surface.

In another embodiment, a side mirror assembly for a vehicle includes a housing configured to be coupled to the vehicle and defining both an interior volume and a mirror aperture, a primary mirror coupled to the housing and extending at least partially across the mirror aperture, a secondary mirror coupled to the housing and extending at least partially across the mirror aperture, and a support movably coupled to the housing and fixedly coupled to at least one of the primary mirror and the secondary mirror. The primary mirror has a first inner surface facing towards the interior volume and a first outer surface opposite the first inner surface. The primary mirror is reflective and provides a first field of view. The secondary mirror has a second inner surface facing towards the interior volume and a second outer surface opposite the second inner surface. The secondary mirror is reflective and provides a second field of view different from the first field of view. The interior volume extends behind both the primary mirror and the secondary mirror. The second outer surface of the secondary mirror extends behind the first inner surface of the primary mirror. A visible reflective area of the first outer surface is larger than a visible reflective area of the second outer surface.

In yet another embodiment, a mirror system for a side mirror of a vehicle includes a support configured to be movably coupled to a housing of the side mirror, a primary mirror having a first outer surface disposed at a first angle relative to a user and a first inner surface opposite the first outer surface and coupled to the support, a secondary mirror having a second outer surface disposed at a second angle relative to the user and a second inner surface opposite the first outer surface and coupled to the support. The primary mirror is reflective and provides a first field of view. The secondary mirror is reflective and provides a second field of view different from the first field of view. The primary mirror and the secondary mirror are arranged such that the primary mirror is at least partially superimposed on the secondary mirror, thereby defining an overlapped area of the second outer surface. A visible reflective area of the first outer surface is larger than a visible reflective area of the second outer surface.

These and other features, together with the organization and manner of operation thereof, may become apparent from the following detailed description when taken in conjunction with the accompanying drawings.

### BRIEF DESCRIPTION OF THE FIGURES

FIG. 1A is a perspective view of a side mirror of a vehicle, according to an exemplary embodiment;

FIG. 1B is a top view of a vehicle incorporating the side mirror shown in FIG. 1A and illustrating the fields of view of the side mirror;

FIG. 2 is a front view of a mirror system of the side mirror shown in FIG. 1A, according to an exemplary embodiment;

FIG. 3 is a front view of the mirror system shown in FIG. 2 showing certain components as transparent;

FIG. 4 is an exploded view of the mirror system shown in FIG. 2;

FIG. 5 is a front view of a mirror system of the side mirror shown in FIG. 1A showing certain components as transparent, according to another exemplary embodiment;

FIG. 6 is an exploded view of the mirror system shown in FIG. 5;

FIG. 7 is a perspective view of a mirror system of the side mirror shown in shown in FIG. 1A, according to another exemplary embodiment;

FIG. 8 is an exploded view of the mirror system shown in FIG. 7;

FIG. 9 is a front view of the mirror system shown in FIG. 7 illustrating the movement of a back plate of the mirror system;

FIG. 10 is a side section view of the mirror system shown in FIG. 7;

FIGS. 11A-11C are side section views of the mirror system shown in FIG. 7, illustrating the movement of the back plate;

FIGS. 12A-12E are various views of the mirror system shown in FIG. 7, illustrating the process of assembling the mirror system;

FIG. 13 is a perspective view of a side mirror of a vehicle, according to another exemplary embodiment;

FIG. 14 is an exploded view of the side mirror shown in FIG. 13;

FIG. 15A is an exploded view of a portion of the side mirror shown in FIG. 13, according to an alternative embodiment; and

FIG. 15B is a section view of the portion shown in FIG. 15A.

### DETAILED DESCRIPTION

Referring to the Figures generally, systems, methods, and apparatuses for a side mirror assembly for a vehicle including a spotter mirror are shown according to various exemplary embodiments.

According to one embodiment, a side mirror assembly includes a primary mirror and a secondary mirror coupled to a housing. The primary mirror provides a driver with a first field of view, and the secondary mirror provides the driver with a second, different field of view. For example, the secondary mirror can provide a field of view that shows an area corresponding to a blind spot or an area behind the vehicle. The primary mirror and the secondary mirror are coupled to one or more back plates using one or more backers (e.g., layers of material) that act as adhesive. The back plates are coupled to the housing and may facilitate adjustment of the orientation of primary mirror and/or the secondary mirror to adjust their respective fields of view. In some embodiments, the primary mirror and the secondary mirror are attached by separate back plates. The backers may include a heating element configured to provide thermal energy to the primary mirror and/or the secondary mirror, melting any snow or ice attached thereto. In some embodiments, either the primary mirror or the secondary mirror is at least partially superimposed over the other.

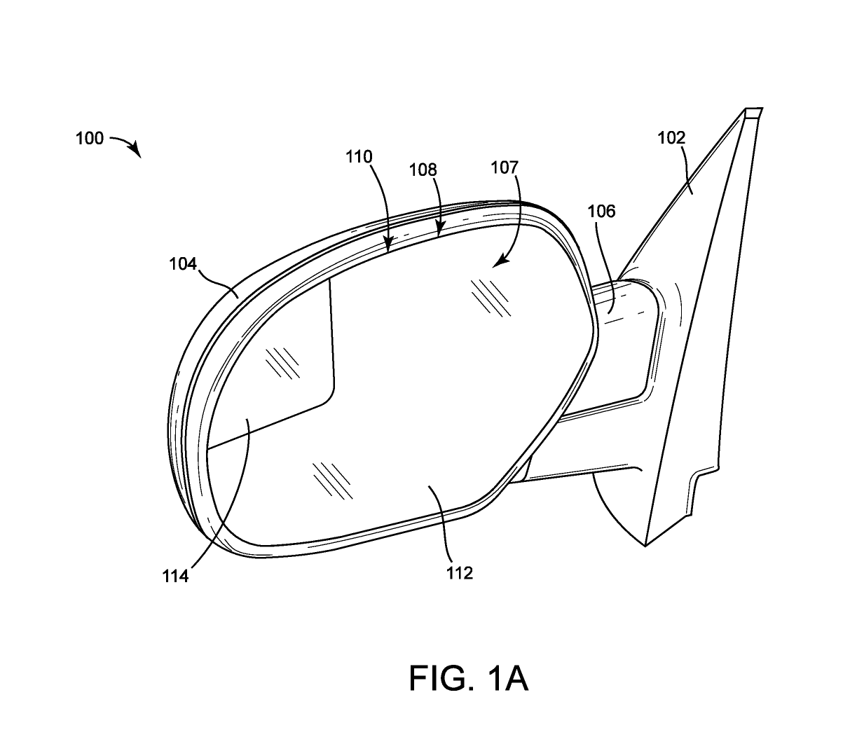

Referring to FIGS. 1A and 1B, a side mirror assembly, shown as side mirror 100, is configured for use with a vehicle 10. The side mirror 100 is configured to extend laterally outward from a side of a body of the vehicle 10 (i.e., outboard) near a front end of the vehicle 10, where the front end of the vehicle 10 is defined with respect to a direction of travel of the vehicle 10. The side mirror 100 facilitates rearward vision of a driver along a side of the vehicle 10. The vehicle 10 may utilize a side mirror 100 on each lateral side of the vehicle 10, arranged such that a driver of the vehicle 10 may have a rearward field of view along both lateral sides of the vehicle 10 from a single position within the vehicle 10 (e.g., from a driver's seat). The side mirror 100 includes a base, shown as base member 102, configured to couple the side mirror 100 to the body of the vehicle 10 (e.g., to a door, to a frame member proximate a door, etc.). The side mirror 100 includes a main body, shown as housing 104, offset outboard from the base member 102. A support member, shown as arm 106, extends between the housing 104 and the base member 102, coupling the housing 104 to the base member 102. The arm 106 may be pivotable at a point along its length (e.g., relative to the base member 102) to facilitate rotation of the housing 104 toward or away from the body of the vehicle 10, thereby adjusting the overall width of the vehicle 10 and the side mirrors 100 (e.g., for parking the vehicle 10 in a narrow space). The housing 104 defines both an interior volume 107 within an interior of the housing 104 and a mirror aperture 108 extending outward from the interior volume 107.

Referring again to FIGS. 1A and 1B, a mirror subassembly, shown as mirror system 110, is coupled to the housing 104. The mirror system 110 includes a first reflective element, shown as primary mirror 112, and a secondary reflective element, shown as spotter mirror or secondary mirror 114, disposed within the mirror aperture 108 of the housing 104. The primary mirror 112 and the secondary mirror 114 face rearward relative to the direction of travel of the vehicle 10 (i.e., have a rearward field of view). The primary mirror 112 is configured to have a first field of view that is directed rearward and alongside the vehicle 10. The secondary mirror 114 is configured to have a second field of view that is directed rearward and alongside the vehicle 10 that is different from the field of view of the primary mirror 112. By way of example, the field of view of the secondary mirror 114 may not overlap (i.e., may be completely outside of) the field of view of the primary mirror 112. Such an example is illustrated in FIG. 1B, where areas PL and SL illustrate the fields of view of the primary mirror 112 and the secondary mirror 114, respectively, for a side mirror 100 on the left side of the vehicle 10, and areas PR and SR illustrate the corresponding fields of view for a side mirror 100 on the right side of the vehicle 10. By way of another example, the field of view of the secondary mirror 114 may partially overlap the field of view of the primary mirror 112.

The primary mirror 112 is larger than the secondary mirror 114, and provides a relatively large field of view (e.g., a wide angle field of view). The secondary mirror 114 is smaller than the primary mirror 112 and may provide a relatively narrow, targeted field of view smaller than that of the primary mirror 112. The relative sizes of the fields of view may vary. The field of view of the secondary mirror 114 may or may not overlap (i.e., may show a different area than) the field of view of the primary mirror 112. By way of example, the field of view of the secondary mirror 114 may show a blind spot (e.g., adjacent the side of the vehicle 10 to which the side mirror 100 is attached) that is not shown in the primary mirror 112. The field of view of the secondary mirror 114 may be angled relative to the field of view of the primary mirror 112 to provide different fields of view, even with adjacent mirror locations. The secondary mirror 114 provides additional intelligence to the driver that is useful throughout a variety of situations. By way of example, the secondary mirror 114 may be used when moving the vehicle 10 to an adjacent lane on a highway to determine if another vehicle is present in a blind spot adjacent the vehicle 10, avoiding a collision. In such an embodiment, the secondary mirror 114 shows a portion of the adjacent lane immediately adjacent the vehicle 10.

In some embodiments, the primary mirror 112 and the secondary mirror 114 are made from a transparent substrate with a reflective coating. The substrate may be made from glass, polymer, or another transparent material. In some such embodiments, the substrate includes multiple layers of different materials (e.g., a relatively thick layer of polymer with a relatively thin layer of glass opposite the reflective coating). The reflective coating may be a metal (e.g., silver, aluminum, etc.). The reflective coating may cover the entirety of one side of the substrate. In some embodiments, parts of the mirrors are arranged such that the substrate is an exposed part of the exterior, and the reflective coating faces outward from the interior volume 107 and is not exposed.

Different drivers operating the vehicle 10 may have bodies with varying dimensions (e.g., heights) and may have varying sight preferences (e.g., preferred fields of view). Accordingly, the primary mirror 112 and/or the secondary mirror 114 may be actuatable or otherwise adjustable relative to the housing 104 to a desired orientation chosen by the driver. By way of example, the primary mirror 112 and/or the secondary mirror 114 may be rotatable relative to the housing 104 about a vertical axis and/or a horizontal axis. The side mirror 100 may include one or more powered elements (e.g., electric motors, etc.) that actuate the primary mirror 112 and/or the secondary mirror 114 in response to a user input. In some such embodiments, the vehicle 10 includes a user interface (e.g., a joystick, a touchscreen, a button, etc.) disposed within an interior of the vehicle 10 and configured to receive user inputs or commands and operate the powered elements. Wires facilitating electrical and/or data connection between the vehicle 10 and the powered elements may pass though the base member 102 and the arm 106 into the housing 104. In other embodiments, the primary mirror 112 and/or the secondary mirror 114 are held in place by a friction element (e.g., a ball and socket joint) that facilitates movement of the respective mirror when acted upon by a substantial outside force (e.g., a driver pushing on a face of the mirror) but prevents inadvertent movement of the respective mirror (e.g., due to vibration of the vehicle 10). The powered elements and/or the friction elements may be housed within the interior volume 107 of the housing 104. In some embodiments, the primary mirror 112 and/or the secondary mirror 114 are fixed relative to one another or to the housing 104.

The primary mirror 112 and the secondary mirror 114 may be concave, convex, aspheric, planar (i.e., flat), or have a combination of multiple curvatures. In one example illustrating a combination of multiple curvatures, the secondary mirror 114 may have a planar portion near the center and a curvature near one or more edges. The primary mirror 112 and/or the secondary mirror 114 may perform optical manipulation on the image reflected to the driver based on the curvature of the respective mirror. By way of example, the secondary mirror 114 may be a convex mirror that minifies an image of an object such that the image of the object appears smaller than the actual object. In other embodiments, the primary mirror and/or secondary mirror may provide unity magnification (i.e., provide an image with no size distortion). By way of example, the primary mirror 112 may be a planar mirror that provides unity magnification.

As shown in FIG. 1A, the primary mirror 112 extends from a top edge to a bottom edge and from an outboard edge to an inboard edge of the mirror aperture 108. The secondary mirror 114 extends from the outboard edge and from the top edge of the mirror aperture 108. In other embodiments, the primary mirror 112 and/or secondary mirror 114 may extend from other edges. By way of example, the primary mirror 112 may extend from the inboard edge and from the top edge to the bottom edge, and the secondary mirror 114 may extend from the outboard edge and from the top edge to the bottom edge, such that the primary mirror 112 forms an inboard portion of the mirror system 110 and the secondary mirror 114 forms an outboard portion of the mirror system 110. In yet other embodiments, the secondary mirror 114 may not extend to any edge, such that the secondary mirror 114 is surrounded by the primary mirror 112. As shown in FIG. 1A, the secondary mirror 114 is positioned in an outboard and upper portion of the mirror system 110. In other embodiments, the secondary mirror 114 may be positioned in a different portion of the mirror system 110 (e.g., a lower portion, an inboard portion, an outboard and lower portion, an inboard and upper portion, an inboard and lower portion, etc.).

According to various embodiments, the side mirror 100 may contain lights (e.g., driving lights, directional lights, proximity awareness lights, security lights, alarm lights, etc.). The primary mirror 112 and the secondary mirror 114 may both or either be magnified or tinted depending on an application of mirror system 110. Further, the shape, size, and configuration of any of the components of the side mirror 100 may be altered depending on an application of the side mirror 100. The primary mirror 112 and/or the secondary mirror 114 may be set to positions automatically by a processing circuit in the vehicle 10. The processing circuit may access a memory that stores presets or instructions for particular orientations and configurations of the primary mirror 112 and/or the secondary mirror 114.

The side mirror 100 may be utilized by a variety of vehicles. For example, side mirror 100 may be utilized by trucks, delivery trucks, delivery vans, refuse trucks, construction vehicles, agricultural vehicles, emergency vehicles, military vehicles, cars, race cars, competition vehicles, motorcycles, mopeds, scooters, bicycles, aircraft, and other vehicles.

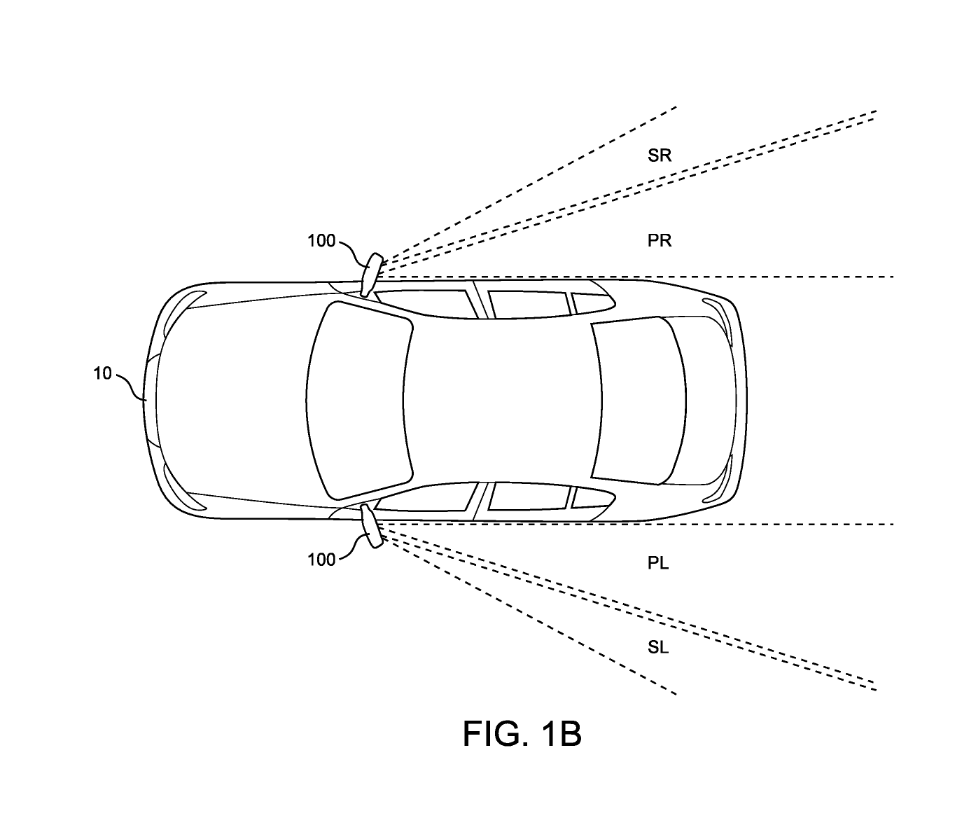

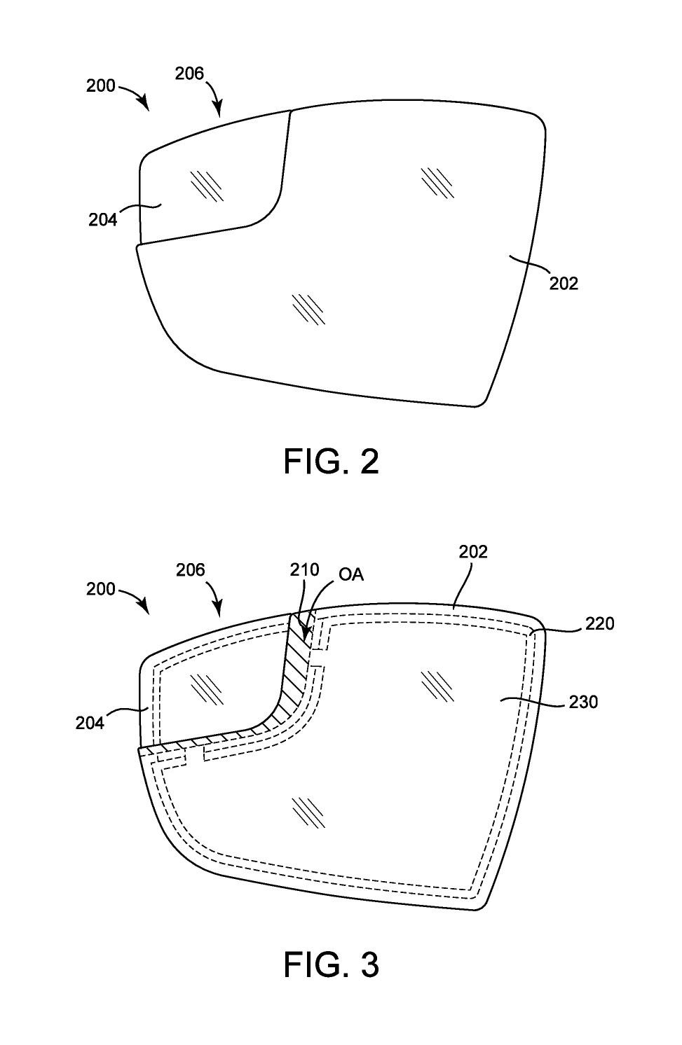

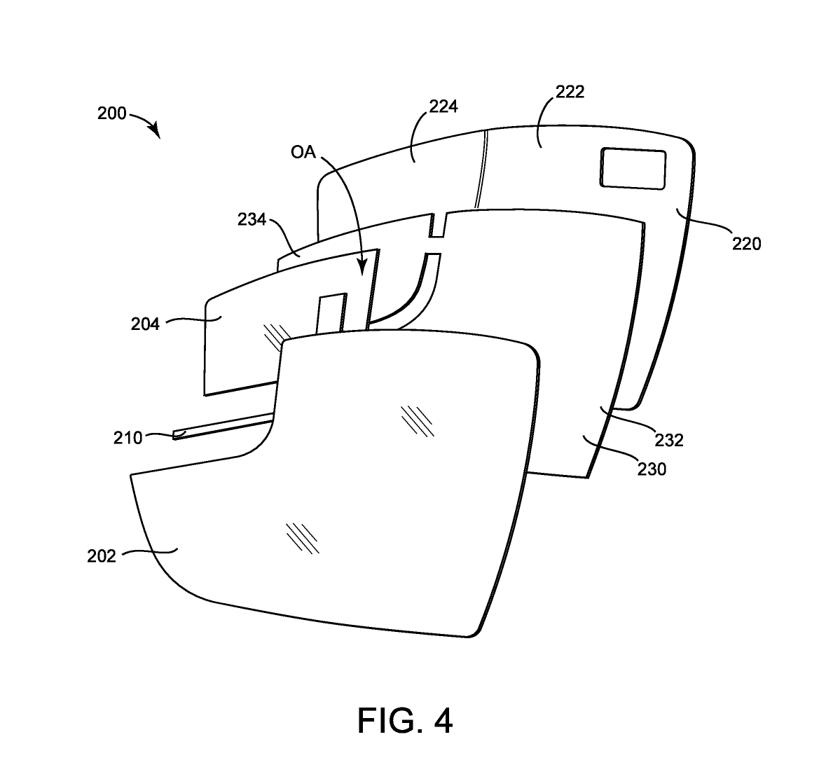

Referring to FIGS. 2-4, a mirror system 200 is shown according to an alternative embodiment. The mirror system 200 may be substantially similar to the mirror system 110 except as otherwise stated. The mirror system 200 includes a primary mirror 202 and a secondary mirror 204. The mirror system 200 is configured to be inserted into the mirror aperture 108 of the housing 104 such that the portion of the mirror system 200 shown in FIG. 2 is exposed. As shown and described herein, the front side of the mirror system 200 faces rearward with respect to the direction of travel of the vehicle 10. The primary mirror 202 and the secondary mirror 204 each have an inner surface on the rear side that faces toward the interior volume 107 of the housing 104 and an outer surface on the front side opposite the inner surface that is at least partially exposed and faces towards the user. The outer surface of the primary mirror 202 is disposed at a first angle relative to the user (e.g., the driver), and the outer surface of the secondary mirror 204 is disposed at a second angle relative to the user. The first angle may or may not be equal to the second angle. As shown in FIGS. 3 and 4, the secondary mirror 204 is disposed behind the primary mirror 202 (e.g., such that the outer surface of the secondary mirror 204 extends behind the inner surface of the primary mirror 202). Instead of extending over the entire area of the mirror aperture 108 of the housing 104, a portion of the primary mirror 202 is cut away, defining a secondary mirror aperture 206 between the primary mirror 202 and the edges of the mirror aperture 108. The secondary mirror 204 extends across the secondary mirror aperture 206, extending between the primary mirror 202 and the edges of the mirror aperture 108 such that the secondary mirror 204 is visible from the exterior of the side mirror 100. In some embodiments, the primary mirror 202 and the secondary mirror 204 are arranged such that they cooperate to extend across the entirety of the mirror aperture 108. The secondary mirror 204 is larger than the secondary mirror aperture 206, such that a portion of the primary mirror 202 is superimposed on or over (i.e., covers, extends directly in front of) a portion of the secondary mirror 204. The area of the outer surface of the secondary mirror 204 covered by the primary mirror 202 is referred to herein as an overlapped area OA. A visible reflective area of the outer surface of the primary mirror 202 is visible to an observer positioned remotely from the side mirror 100 (e.g., is not obscured by the housing 104 or another component of the mirror system 200). A visible reflective area of the outer surface of the secondary mirror 204 is visible to an observer positioned remotely from the side mirror 100 (e.g., is not obscured by the housing 104 or another component of the mirror system 200). The visible reflective area of the outer surface of the secondary mirror 204 does not include the overlapped area OA.

Referring to FIG. 4, an exploded view of the mirror system 200 is shown. A first support, section of material, adhesive section, barrier, or gasket, shown as support 210, is disposed between the primary mirror 202 and the secondary mirror 204. The support 210 is fixedly coupled to the outer surface of the secondary mirror 204 and the inner surface of the primary mirror 202 such that the support 210 couples the primary mirror 202 to the secondary mirror 204. In addition to supporting the primary mirror 202 and the secondary mirror 204, the support 210 prevents debris (e.g., snow, dust, insects, etc.) from entering the side mirror 100 between the primary mirror 202 and the secondary mirror 204. As shown in FIGS. 3 and 4, the support 210 is in some embodiments sized to exactly match the overlapped area OA and extends over the entirety of the overlapped area OA. Accordingly, the support 210 extends directly between the primary mirror 202 and the secondary mirror 204. In other embodiments, the support 210 may extend beyond the overlapped area OA or may extend over only a portion of the overlapped area OA. In yet other embodiments, the support 210 extends indirectly between the primary mirror 202 and the secondary mirror 204. By way of example, the support 210 may be coupled to the outer surface of the primary mirror 202, extend laterally beyond the primary mirror 202, and extend backward to couple to the outer surface of the secondary mirror 204. In some embodiments, the support 210 is a thin layer of adhesive material (e.g., cyanoacrylate glue, polyurethane glue, epoxy, etc.) without additional material disposed within the adhesive material. In other embodiments, the support 210 includes a substrate or section of base material (e.g., foam, rubber, plastic, etc.) coated on either side with an adhesive material or including clips, fasteners, or another connection method to couple to the primary mirror 202 and the secondary mirror 204. The substrate may have sufficient thickness to separate the primary mirror 202 and the secondary mirror 204 such that the inner surface of the primary mirror 202 is offset a distance from the outer surface of the secondary mirror 204 (e.g., to prevent noise or damage to the mirrors due to vibration, such that the substrate provides sufficient structure to prevent relative movement between the primary mirror 202 and the secondary mirror 204, etc.). The substrate may be formed to match the contours of the primary mirror 202 and/or the secondary mirror 204. Alternatively, the primary mirror 202 may contact the secondary mirror 204 such that the inner surface of the primary mirror 202 is not offset from the outer surface of the secondary mirror 204.

Referring again to FIG. 4, the mirror system 200 includes a second support, shown as back plate 220, and a layer of backing material, shown as backer 230. The back plate 220 supports the other components of the mirror system 200. In some embodiments, the back plate 220 is rigid. The back plate 220 couples the friction element or the powered elements to the mirror system 200, and as such couples the mirror system 200 to the housing 104. Accordingly, the back plate 220 may include fasteners, apertures, or other geometry to facilitate interfacing with the friction elements or powered elements. The back plate 220 extends along a rear side (e.g., along the inner surface) of the primary mirror 202 and a rear side (e.g., along the inner surface) of the secondary mirror 204. The backer 230 extends between the primary mirror 202 and the back plate 220 and between the secondary mirror 204 and the back plate 220. The backer 230 fixedly couples the primary mirror 202 and the secondary mirror 204 to the back plate 220. Accordingly, the backer 230 extends along the inner surface of the primary mirror 202 and along the inner surface of the secondary mirror 204. In some embodiments, the backer 230 is a thin layer of adhesive (e.g., cyanoacrylate glue, polyurethane glue, epoxy, etc.) without additional material. In other embodiments, the backer 230 includes a substrate or section of base material (e.g., foam, rubber, plastic, etc.) coated on either side with an adhesive material. Due to the coupling of the secondary mirror 204 to the primary mirror 202, the secondary mirror 204 and the primary mirror 202 are stationary or fixed relative to one another. Accordingly, movement of the back plate 220 (e.g., by the powered element, by hand, etc.) moves both the primary mirror 202 and the secondary mirror 204 simultaneously and similarly. By way of example, if the primary mirror 202 is rotated about a vertical axis, the secondary mirror 204 is also rotated about the same vertical axis.

The back plate 220 includes a first section 222 configured to support the primary mirror 202 and a second section 224 configured to support the secondary mirror 204. The second section 224 may be offset toward the rear end of the mirror system 200 relative to the first section 222 to accommodate the thickness of the secondary mirror 204 and the support 210 extending from the rear surface of the primary mirror 202. The first section 222 and the second section 224 may be shaped similarly to the mirrors to which they are coupled. By way of example, the first section 222 may be flat to accommodate a primary mirror 202 that has a planar inner surface. By way of another example, the second section 224 may be convex to accommodate a secondary mirror 204 that has a concave inner surface. The first section 222 and the second section 224 may be angled relative to one another to adjust the relative angle between the fields of view of the primary mirror 202 and the secondary mirror 204. The first section 222 and the second section 224 are part of a single continuous element. By way of example, the back plate 220 may be formed from a single injection molded piece of polymeric material.

The backer 230 includes a first section 232 configured to contact the primary mirror 202 and a second section 234 configured to contact the secondary mirror 204. The second section 234 may be offset toward the rear end of the mirror system 200 relative to the first section 232 to accommodate the thickness of the secondary mirror 204 and the support 210 extending from the inner surface of the primary mirror 202. The backer 230 may be flexible such that it conforms to the shapes of the mirrors and the back plate 220. The backer 230 may have sufficient thickness to facilitate the relative placement of various components. The first section 232 and the second section 234 of the backer 230 may be part of a single continuous piece of material and bent or folded to offset the second section 234 from the first section 232, or the first section 232 and the second section 234 may be separate pieces.

In some embodiments, the backer 230 includes a heating element configured to heat (i.e., apply or provide thermal energy to) the primary mirror 202 and the secondary mirror 204. By way of example, the backer 230 may include a resistive element (e.g., a thin electrically conductive wire) spread over the area of the backer 230 that releases thermal energy when an electrical current is applied to the resistive element. In some embodiments, the backer 230 is thermally conductive to facilitate distribution of the thermal energy. The thermal energy from the heating element facilitates the removal of snow or ice from the side mirror 100 that may build up in cold climates.

In an alternative embodiment, the secondary mirror 204 is superimposed on the primary mirror 202. In such an embodiment, all or a portion of the support 210 may be disposed behind the secondary mirror 204 and in front of the primary mirror 202, between the two mirrors. The second section 224 of the back plate 220 and the second section 234 of the backer 230 are offset toward the front end of the mirror system 200 to meet the secondary mirror 204. In such embodiments, the portion of the primary mirror 202 that is cut away may be relatively small without affecting the visibility of the secondary mirror 204.

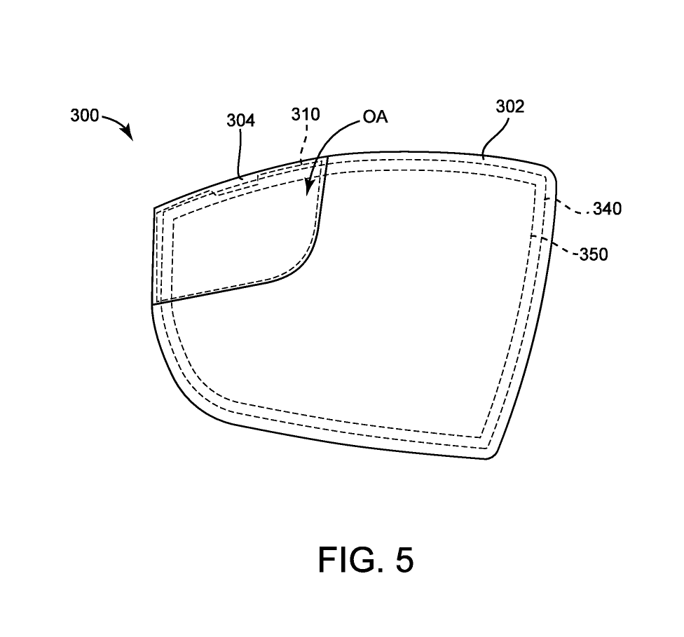

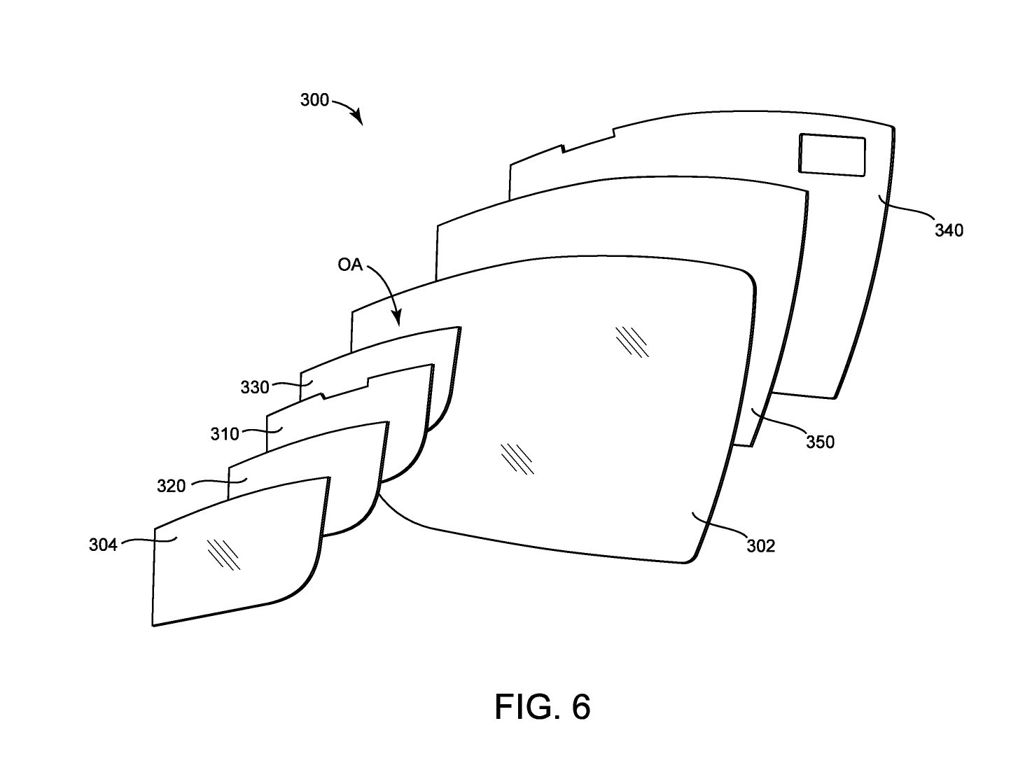

Referring to FIGS. 5 and 6, a mirror system 300 is shown according to an alternative embodiment. The mirror system 300 may be substantially similar to the mirror system 200 except as otherwise stated. The mirror system 300 includes a primary mirror 302 and a secondary mirror 304. The mirror system 300 is configured to be inserted into the mirror aperture 108 of the housing 104 such that the portion of the mirror system 300 shown in FIG. 5 is exposed. As shown and described herein, the front side of the mirror system 300 faces rearward with respect to the direction of travel of the vehicle 10. The primary mirror 302 and the secondary mirror 304 each have an inner surface on the rear side that faces toward the interior volume 107 of the housing 104 and an outer surface on the front side opposite the inner surface that is at least partially exposed and faces towards the user (e.g., the driver). The outer surface of the primary mirror 302 is disposed at a first angle relative to the user, and the outer surface of the secondary mirror 304 is disposed at a second angle relative to the user. The first angle may or may not be equal to the second angle. As shown in FIG. 5, the secondary mirror 304 is disposed in front of the primary mirror 302 (e.g., such that the inner surface of the secondary mirror 304 extends in front of the outer surface of the primary mirror 302). The primary mirror 302 extends over the entire area of the mirror aperture 108 of the housing 104. The secondary mirror 304 is coupled to the front side of the primary mirror 302 such that the secondary mirror 304 is visible from the exterior of the side mirror 100. The entirety of the secondary mirror 304 is superimposed on a portion of the primary mirror 302. The area of the primary mirror 302 covered by the secondary mirror 304 is referred to herein as an overlapped area OA. A visible reflective area of outer surface of the primary mirror 302 is visible to an observer positioned remotely from the side mirror 100 (e.g., is not obscured by the housing 104 or another component of the mirror system 300). A visible reflective area of the outer surface of the secondary mirror 304 is visible to an observer positioned remotely from the side mirror 100 (e.g., is not obscured by the housing 104 or another component of the mirror system 300). The visible reflective area of the outer surface of the primary mirror 302 does not include the overlapped area OA.

Referring to FIG. 6, an exploded view of the mirror system 300 is shown. Instead of a single back plate supporting both the primary mirror 302 and the secondary mirror 304 similar to the mirror system 200, the mirror system 300 utilizes two separate back plates, one corresponding to each mirror. The separation of the back plates facilitates placement of the secondary mirror 304 anywhere within the mirror aperture 108. The mirror system 300 includes a support, shown as back plate 310, configured to be coupled to a rear side of the secondary mirror 304. The back plate 310 is configured to support the secondary mirror 304. A layer of backing material, shown as backer 320, is disposed between the back plate 310 and the secondary mirror 304. The backer 320 has adhesive material on both sides that couples the back plate 310 to the secondary mirror 304. A support, section of material, adhesive section, barrier, or gasket, shown as support 330, is disposed between the back plate 310 and the primary mirror 302. The support 330 may be may be similar (e.g., in materials, in construction methods, in features, in properties, etc.) to the support 210. The support 330 couples the primary mirror 302 to the back plate 310, and by extension to the secondary mirror 304. The support 330 may extend over the entire overlapped area OA or a portion of the overlapped area OA. The mirror system 300 includes a support, shown as back plate 340, that supports the primary mirror 302 and, by extension, the other components of the mirror system 300. A layer of backing material, shown as backer 350, is disposed between the back plate 340 and the primary mirror 302. The backer 350 has adhesive material on both sides that couples the back plate 340 to the primary mirror 302. The back plate 340 is configured to be coupled to the powered element or the friction element. Due to the coupling of the primary mirror 302 and the secondary mirror 304 to the back plate 340, movement of the back plate 340 (e.g., by the powered element, by hand, etc.) moves both the primary mirror 302 and the secondary mirror 304 simultaneously and similarly.

The back plate 310 and the back plate 340 may be similar (e.g., in materials, in construction methods, in features, in properties, etc.) to the back plate 220. The back plate 310 may be formed to match the shape of the secondary mirror 304 and/or the primary mirror 302, and the back plate 340 may be formed to match the shape of the primary mirror 302. By way of example, the back plate 310 may be convex on one side to match the secondary mirror 304 and flat on the other to match the primary mirror 302. The back plate 310 and the back plate 340 may be angled relative to one another to adjust the relative angle between the fields of view of the primary mirror 302 and the secondary mirror 304. The backer 320 and the backer 350 may be similar (e.g., in materials, in construction methods, in features, in properties, etc.) to the backer 230. In some embodiments, the backer 320 and/or the backer 350 include a heating element, similar to the heating element in the backer 230. The backer 320 and the backer 350 may be separate or formed from a single continuous piece of material. Accordingly, the continuous piece of material may be folded to reach both the secondary mirror 304 and the primary mirror 302, accounting for the thickness of the primary mirror 302, the back plate 310, and the support 330. In some embodiments, the backer 320 and the backer 350 are formed from separate pieces of material, but the heating element extends between both pieces.

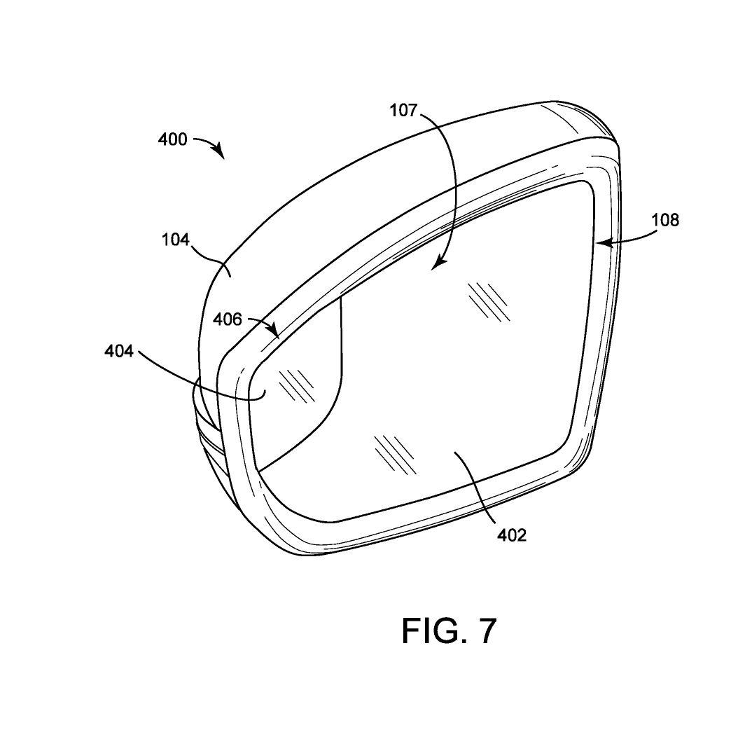

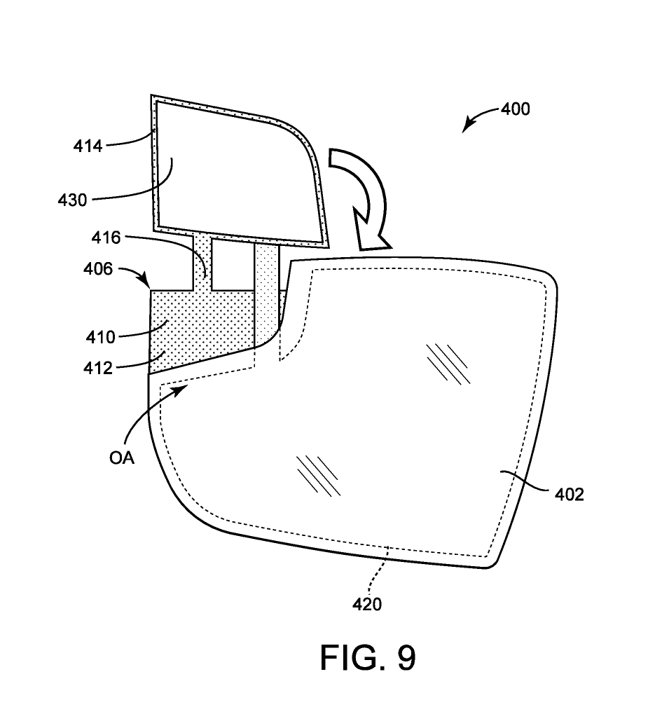

Referring to FIGS. 7-12E, a mirror system 400 is shown according to an alternative embodiment. The mirror system 400 may be substantially similar to the mirror system 300, except as otherwise stated. The mirror system 400 includes a primary mirror 402 and a secondary mirror 404. As shown and described herein, the front side of the mirror system 400 faces rearward with respect to the direction of travel of the vehicle 10. The primary mirror 402 and the secondary mirror 404 each have an inner surface on the rear side that faces toward the interior volume 107 of the housing 104 and an outer surface on the front side opposite the inner surface that is at least partially exposed and faces towards the user. The outer surface of the primary mirror 402 is disposed at a first angle relative to the user (e.g., the driver), and the outer surface of the secondary mirror 404 is disposed at a second angle relative to the user. The first angle may or may not be equal to the second angle. As shown in FIG. 7, the secondary mirror 404 is disposed in front of the primary mirror 402 (e.g., such that the inner surface of the secondary mirror 404 extends in front of the outer surface of the primary mirror 402). Instead of extending over the entire area of the mirror aperture 108 of the housing 104, a portion of the primary mirror 402 is cut away, similar to the mirror system 200, defining a secondary mirror aperture 406 shown in FIG. 9. The secondary mirror 404 extends across the secondary mirror aperture 406, extending between the primary mirror 402 and the exterior of the mirror aperture 108. In some embodiments, the primary mirror 402 and the secondary mirror 404 are arranged such that they cooperate to extend across the entirety of the mirror aperture 108. The secondary mirror 404 is larger than the secondary mirror aperture 406, such that a portion of the secondary mirror 404 is superimposed on a portion of the primary mirror 402.

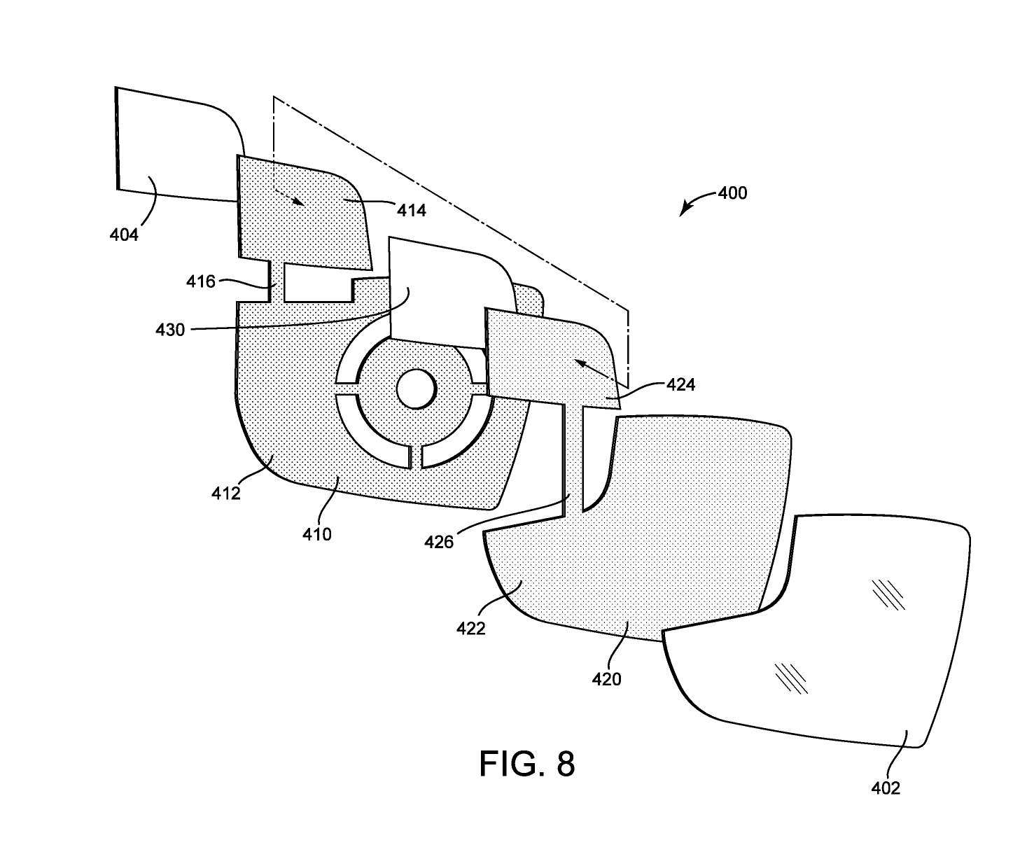

FIG. 8 shows an exploded view of the mirror system 400. The mirror system 400 includes a support, shown as back plate 410. A layer of backing material, shown as backer 420, is disposed between the back plate 410 and the primary mirror 402. The backer 420 includes adhesive material on both sides with which to couple the primary mirror 402 and the secondary mirror 404 to the back plate 410. The back plate 410 may be similar (e.g., in materials, in construction methods, in features, in properties, etc.) to the back plate 220, and the backer 420 may be similar to the backer 230. The back plate 410 has a first section 412, to which the primary mirror 402 is coupled, and a second section 414, to which the secondary mirror 404 is coupled. The back plate 410 includes a connecting section 416 that extends between the first section 412 and the second section 414. Similarly, the backer 420 has a first section 422 coupling the primary mirror 402 to the first section 412 of the back plate 410, a second section 424 coupling the secondary mirror 404 to the second section 414 of the back plate 410, and a connecting section 426 coupling the first section 422 and the second section 424 of the backer 420. Any of the sections of the backer 420 may include a heating element similar to that included in the backer 230. The first section 412 of the back plate 410 is configured to interface with the powered element or frictional element, similar to the back plate 220. The connecting sections of the back plate 410 and the backer 420 are flexible, such that the first section 412 and the second section 414 of the back plate 410 can move relative to one another, as shown in FIG. 9. The connecting sections of the back plate 410 and the backer 420 may be made from inherently flexible materials, and/or the thicknesses of the connecting sections may be reduced to improve their flexibility. In some embodiments, the first section 412, the second section 414, and the connecting section 416 of the back plate 410 are formed from a single injection molded piece of polymeric material. Such embodiments may reduce manufacturing costs, as only one mold would be needed to make the entirety of the back plate 410.

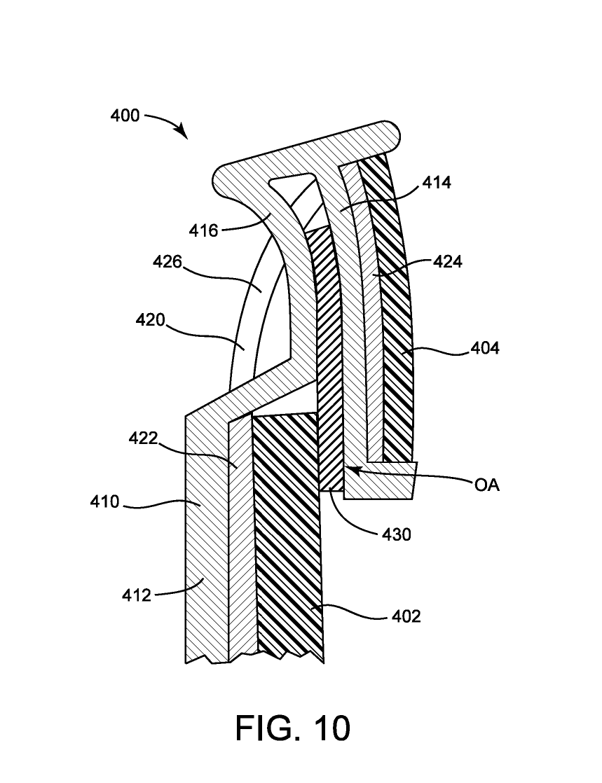

The secondary mirror 404 is coupled to a side of the back plate 410 opposite the side to which the primary mirror 402 is coupled. The second section 424 of the backer 420 extends between the secondary mirror 404 and the second section 414 of the back plate 410, coupling the secondary mirror 404 to the back plate 410. After the primary mirror 402 and the secondary mirror 404 have been coupled to the back plate 410, the second section 414 of the back plate 410 is folded down about an approximately horizontal axis until the second section 414 of the back plate 410 and the secondary mirror 404 extend over the primary mirror 402, resulting in the assembly shown in FIG. 10. Alternatively, the secondary mirror 404 may be added after the second section 414 is folded down. The first section 412 and the second section 414 of the back plate 410 may be angled relative to one another to adjust the relative angle between the fields of view of the primary mirror 402 and the secondary mirror 404.

Once folded, both the secondary mirror 404 and the second section 414 of the back plate 410 are superimposed on the primary mirror 402. The area of the primary mirror 402 covered by the secondary mirror 404 is referred to herein as an overlapped area OA. In some embodiments, the second section 414 of the back plate 410 covers a greater area of the primary mirror 402 than the overlapped area OA. A visible reflective area of the outer surface of the primary mirror 402 is visible to an observer positioned remotely from the side mirror 100 (e.g., is not obscured by the housing 104 or another component of the mirror system 400). A visible reflective area of the outer surface of the secondary mirror 404 is visible to an observer positioned remotely from the side mirror 100 (e.g., is not obscured by the housing 104 or another component of the mirror system 400). The visible reflective area of the outer surface of the primary mirror 402 does not include the overlapped area OA or the area obscured by the second section 414 of the back plate 410.

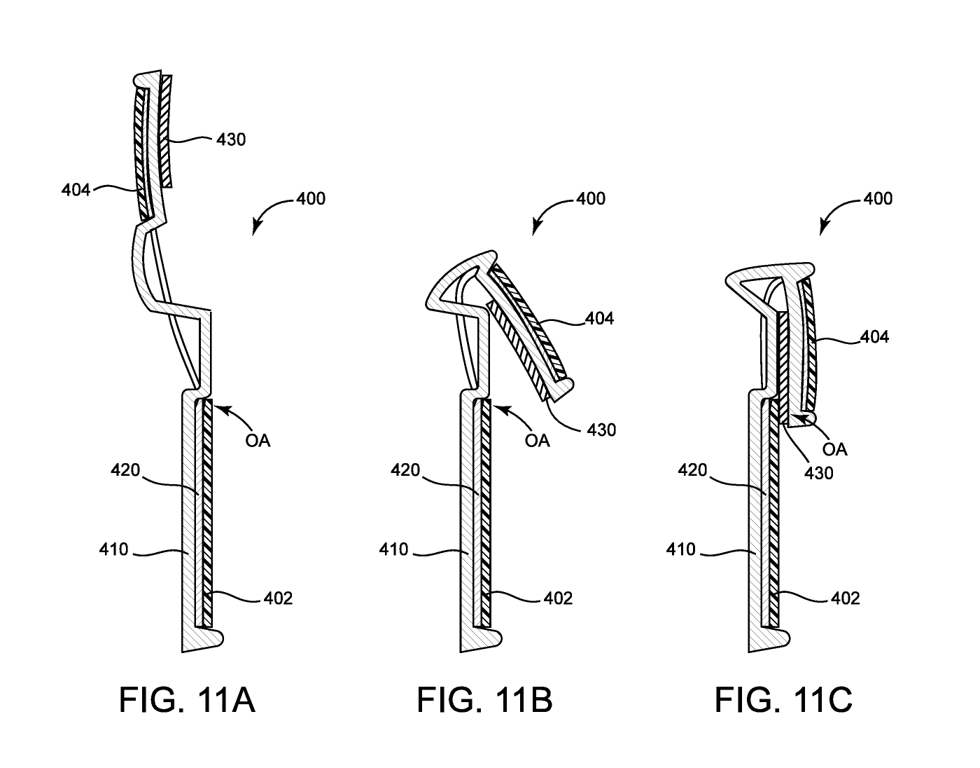

The process of folding the secondary mirror 404 and the back plate 410 is shown from the side in FIGS. 11A-11C. A support, section of material, adhesive section, barrier, or gasket shown as support 430, couples the second section 414 of the back plate 410 to the primary mirror 402. The support 430 fixes the second section 414 of the back plate 410 and, by extension the secondary mirror 404, relative to the primary mirror 402. Accordingly, movement of the back plate 410 (e.g., by the powered element, by hand, etc.) moves both the primary mirror 402 and the secondary mirror 404 simultaneously and similarly. The support 430 may be similar (e.g., in materials, in construction methods, in features, in properties, etc.) to the support 210. In some embodiments, the support 430 extends over the entire overlapped area OA. In some embodiments, the connecting section 416 of the back plate 410 is bent towards the front end of the mirror system 400 above the primary mirror 402, then runs approximately vertically, adjacent the second section 414 of the back plate 410, connecting with the second section 414 of the back plate 410 near a top surface of the second section 414. In some such embodiments, the support 430 extends between and couples the connecting section 416 of the back plate 410 and the second section 414 of the back plate 410, as shown in FIG. 10.

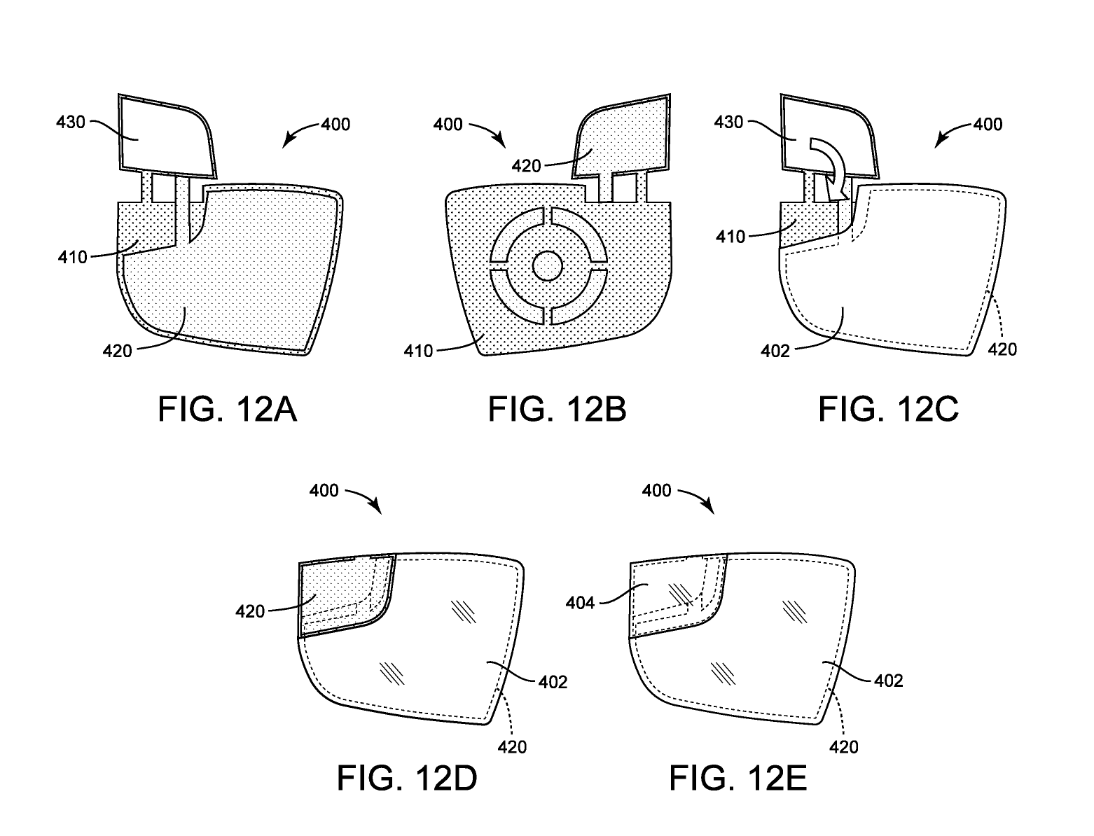

The process of assembling the mirror system 400 is shown in FIGS. 12A-12E. In FIG. 12A, the back plate 410 is laid flat, the first section 422 of the backer 420 is coupled to the front side of the first section 412 of the back plate 410, and the second section 424 of the backer 420 is coupled to the rear side of the second section 414 of the back plate 410. The support 430 is coupled to the front side of the second section 414 of the back plate 410. FIG. 12B shows a rear view of the mirror system 400 shown in FIG. 12A. In FIG. 12C, the primary mirror 402 is adhered to the first section 412 of the back plate 410 using the first section 422 of the backer 420. In FIG. 12D, the second section 414 of the back plate 410 is rotated downwards until the support 430 contacts the primary mirror 402. In FIG. 12E, the secondary mirror 404 is adhered to the second section 414 of the back plate 410 using the second section 424 of the backer 420. Alternatively, the secondary mirror 404 may be adhered to the second section 414 of the back plate 410 prior to rotating the second section 414 downwards, as shown in FIGS. 11A-11C.

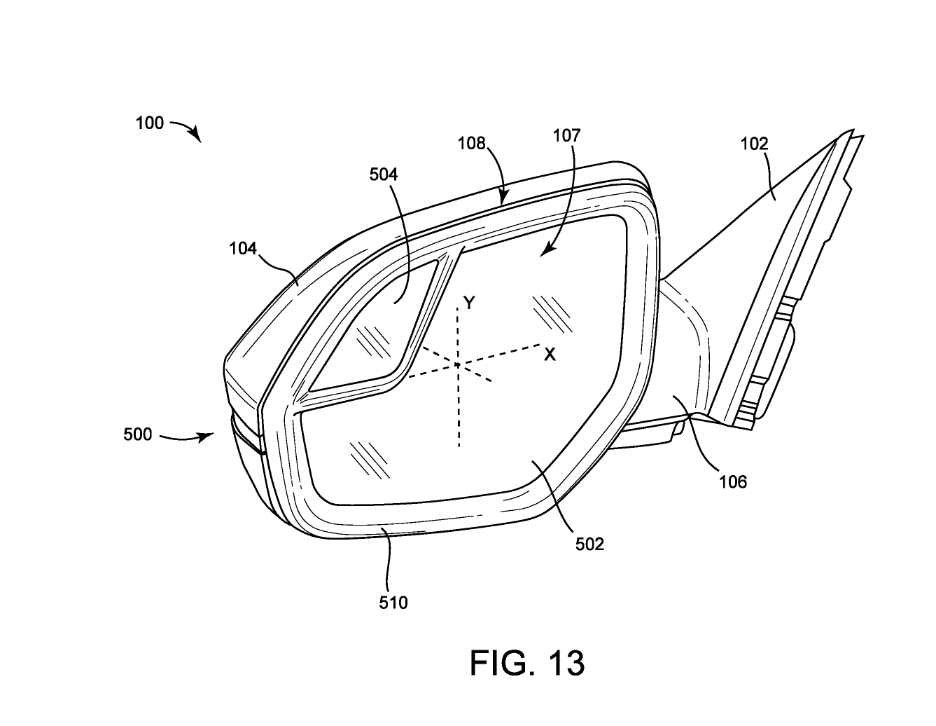

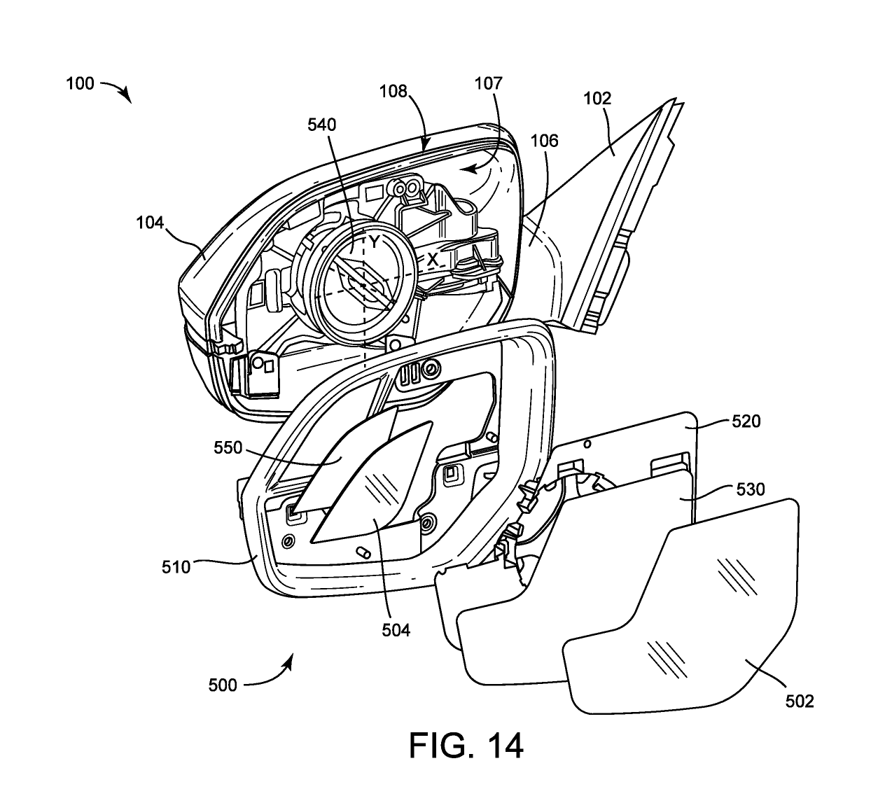

Referring to FIGS. 13 and 14, an alternative embodiment of the side mirror 100 is shown that includes a mirror system 500. As shown and described herein, the front side of the mirror system 500 faces rearward with respect to the direction of travel of the vehicle 10. The primary mirror 502 and the secondary mirror 504 each have an inner surface on the rear side that faces toward the interior volume 107 of the housing 104 and an outer surface on the front side opposite the inner surface that is at least partially exposed and faces towards the user. The outer surface of the primary mirror 502 is disposed at a first angle relative to the user (e.g., the driver), and the outer surface of the secondary mirror 504 is disposed at a second angle relative to the user. The first angle may or may not be equal to the second angle. The mirror system 500 may be substantially similar to the mirror system 110 except as otherwise stated. The mirror system 500 includes a primary mirror 502 and a secondary mirror 504. As shown in FIG. 13, the secondary mirror 504 is disposed adjacent the primary mirror 502. A frame assembly, shown as bezel 510, extends between and separates the primary mirror 502 and the secondary mirror 504. The primary mirror 502, the secondary mirror 504, and the bezel 510 cooperate to extend across the entirety of the mirror aperture 108. A portion of the primary mirror 502 is cut away, forming an aperture between the primary mirror 502 and the housing 104 in which the secondary mirror 504 and a portion of the bezel 510 are disposed. This portion of the bezel 510 separates the primary mirror 502 and the secondary mirror 504. Accordingly, neither of the primary mirror 502 and the secondary mirror 504 are superimposed on one another.

A visible reflective area of the outer surface of the primary mirror 502 is visible to an observer positioned remotely from the side mirror 100 (e.g., is not obscured by the housing 104 or another component of the mirror system 500). A visible reflective area of the outer surface of the secondary mirror 504 is visible to an observer positioned remotely from the side mirror 100 (e.g., is not obscured by the housing 104 or another component of the mirror system 500).

Referring to FIG. 14, an exploded view of the side mirror 100 including the mirror system 500 is shown. The mirror system 500 includes a support, shown as back plate 520, configured to support the primary mirror 502. The back plate 520 may be similar (e.g., in materials, in construction methods, in features, in properties, etc.) to the back plate 220. The back plate 520 extends along the inner surface of the primary mirror 502. In some embodiments, the back plate 520 is rigid. A layer of backing material, shown as backer 530, extends between the primary mirror 502 and the back plate 520. The backer 530 may be or include adhesive with which to couple the primary mirror 502 to the back plate 520. The back plate 520 interfaces with a powered element, shown as actuator 540, that is configured to actuate the primary mirror 502 relative to the housing 104 of the side mirror 100. The actuator 540 is coupled to the housing 104. The actuator 540 and the back plate 520 are configured to interface with one another (e.g., using fasteners, using cooperating geometry of the back plate 520 and the actuator 540, etc.) to facilitate actuation of the primary mirror 502. The actuator 540 is configured to rotate the primary mirror 502 about a horizontal, laterally-extending axis X and a vertical axis Y to adjust the field of view (e.g., the orientation of the field of view, the location of the field of view, etc.) of the primary mirror 502.

Referring again to FIG. 14, the secondary mirror 504 is coupled to the bezel 510 using a layer of backing material, shown as backer 550. The backer 550 may be or include adhesive with which to couple the secondary mirror 504 to the bezel 510. The backer 530 and the backer 550 may be similar (e.g., in materials, in construction methods, in features, in properties, etc.) to the backer 230 of the mirror system 200. The backer 530 and/or the backer 550 may include a heating element similar to that included in the backer 230. The backer 550 extends between the secondary mirror 504 and a mirror support portion of the bezel 510. The mirror support portion of the bezel 510 may be shaped to match the contours of the secondary mirror 504. The bezel 510 is formed from a single piece of injection molded polymeric substrate and may be rigid. The bezel 510 is coupled to the housing 104 of the side mirror 100. Accordingly, the secondary mirror 504 is stationary or fixed relative to the bezel 510 and the housing 104, and the actuator 540 moves the primary mirror 502 relative to the secondary mirror 504.

In other embodiments, the mirror system 500 includes a powered element configured to facilitate adjustment of the secondary mirror 504 relative to the bezel 510. The powered element may include an electric motor or another type of actuator. In such embodiments, the powered element couples the secondary mirror 504 to the housing 104. In some such embodiments, the backer 550 couples the secondary mirror 504 to the powered element. The vehicle 10 may include controls disposed inside of the vehicle 10 for controlling the actuation of the powered element. This arrangement facilitates movement of the secondary mirror 504 independent of the primary mirror 502, allowing the driver to customize the field of view of each mirror independently.

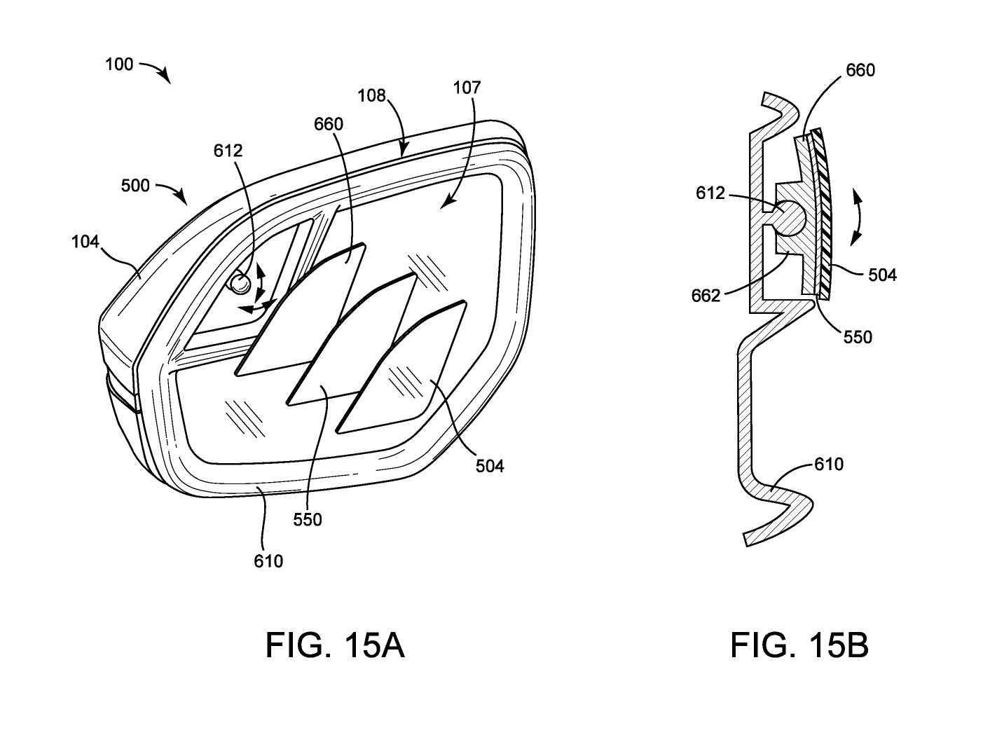

Referring to FIGS. 15A and 15B, a bezel 610 is shown as an alternative embodiment to the bezel 510 shown in FIG. 14. The bezel 610 may be substantially similar to the bezel 510, except as otherwise specified. The bezel 610 includes a protrusion 612 extending therefrom. The distal end of the protrusion 612 is configured to have a spherical curvature. A back plate 660 is configured to be coupled to the bezel 610. Specifically, a rear side of the back plate 660 includes a feature, shown as receiver 662, defining a recess configured to receive the protrusion 612. An inner surface of the receiver 662 is configured with a spherical curvature that corresponds to the curvature of the distal end of the protrusion 612. The receiver 662 receives the protrusion 612 such that the corresponding surfaces contact one another. Accordingly, the back plate 660 is pivotable relative to the bezel 610 in an infinite number of directions. The back plate 660 is repositionable relative to the bezel 610 into an infinite number of positions.

The recess defined by the receiver 662 may have an interior surface intended to retain the protrusion 612 in place (e.g., defining a reduced size opening). This facilitates containing the protrusion 612 within the receiver 662. In some embodiments, the back plate 660 is made from a somewhat flexible material (e.g., plastic) such that the receiver 662 deflects outward to receive the protrusion 612. Once the receiver 662 has received the protrusion 612, the receiver 662 may be biased against the protrusion 612, producing friction that resists movement of the back plate 660 relative to the bezel 610. The receiver 662 may be biased by an elastic property of the receiver 662 or by an additional biasing element (e.g., a spring). The friction facilitates selective repositioning of the back plate 660 (e.g., by a vehicle operator applying a force to the back plate 660), while preventing unintentional repositioning of the back plate 660 (e.g., due to vibration of the vehicle 10). In some embodiments, the corresponding surfaces of the protrusion 612 and the receiver 662 are configured to increase the friction. By way of example, the protrusion 612 may be coated with a layer of material having a high coefficient of friction when in contact with the material used in the back plate 660. The backer 550 is configured to fixedly couple the secondary mirror 504 to the front side of the back plate 660, such that the back plate 660 extends along a back side of the secondary mirror 504.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

The present disclosure is not limited to the particular methodology, protocols, and expression of design elements, etc. described herein and as such may vary. The terminology used herein is for the purpose of describing particular embodiments only, and is not intended to limit the scope of the present disclosure.

As used herein, the singular forms include the plural reference and vice versa unless the context clearly indicates otherwise. The term “or” is inclusive unless modified, for example, by “either.” For brevity and clarity, a particular quantity of an item may be described or shown while the actual quantity of the item may differ. Other than in the operating examples, or where otherwise indicated, all numbers expressing measurements used herein should be understood as modified in all instances by the term “about” allowing for ranges accepted in the art.

Unless defined otherwise, all technical terms used herein have the same meaning as those commonly understood to one of ordinary skill in the art to which this invention pertains. Although any known methods, devices, and materials may be used in the practice or testing of the inventive concepts, the methods, devices, and materials in this regard are described herein.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure.

What is claimed is:

1. A side mirror assembly for a vehicle, comprising:
a housing configured to be coupled to the vehicle and defining both an interior volume and a mirror aperture;
a primary mirror coupled to the housing and extending at least partially across the mirror aperture, wherein the primary mirror has a first inner surface facing towards the interior volume and a first outer surface opposite the first inner surface, wherein the primary mirror is reflective and provides a first field of view;
a secondary mirror coupled to the housing and extending at least partially across the mirror aperture, wherein the secondary mirror has a second inner surface facing towards the interior volume and a second outer surface opposite the second inner surface, wherein the secondary mirror is reflective and provides a second field of view different from the first field of view; and
a support coupled to the housing and at least one of the primary mirror and the secondary mirror;
wherein the primary mirror and the secondary mirror are arranged such that the primary mirror is at least partially superimposed on the secondary mirror, thereby defining an overlapped area of the second outer surface, wherein a visible reflective area of the first outer surface is a larger than a visible reflective area of the second outer surface.

2. The side mirror assembly of claim 1, wherein the second outer surface of the secondary mirror is offset a distance from the first inner surface of the primary mirror.

3. The side mirror assembly of claim 2, wherein the support is a first support, and further comprising a second support coupled to the primary mirror and the secondary mirror and extending between the primary mirror and the secondary mirror adjacent the overlapped area.

4. The side mirror assembly of claim 1, wherein the support is fixedly coupled to both the primary mirror and the secondary mirror such that relative movement between the primary mirror and the secondary mirror is prevented.

5. The side mirror assembly of claim 4, further comprising a backer extending along the first inner surface and the second inner surface, wherein the backer fixedly couples the primary mirror and the secondary mirror to the support.

6. The side mirror assembly of claim 5, wherein the backer includes a heating element configured to provide thermal energy to at least one of the primary mirror and the secondary mirror.

7. The side mirror assembly of claim 1, wherein the first outer surface of the primary mirror has a first curvature, wherein the second outer surface of the secondary mirror has a second curvature, and wherein the first curvature is different from the second curvature.

8. The side mirror assembly of claim 1, wherein the primary mirror and the secondary mirror are fixed relative to the support such that a movement of the support causes a corresponding movement of both the primary mirror and the secondary mirror.

9. A side mirror assembly for a vehicle, comprising:
a housing configured to be coupled to the vehicle and defining both an interior volume and a mirror aperture;
a primary mirror coupled to the housing and extending at least partially across the mirror aperture, wherein the primary mirror has a first inner surface facing towards the interior volume and a first outer surface opposite the first inner surface, wherein the primary mirror is reflective and provides a first field of view;
a secondary mirror coupled to the housing and extending at least partially across the mirror aperture, wherein the secondary mirror has a second inner surface facing towards the interior volume and a second outer surface opposite the second inner surface, wherein the secondary mirror is reflective and provides a second field of view different from the first field of view; and
a support movably coupled to the housing and fixedly coupled to at least one of the primary mirror and the secondary mirror;
wherein the interior volume extends behind both the primary mirror and the secondary mirror, wherein the second outer surface of the secondary mirror extends behind the first inner surface of the primary mirror, and wherein a visible reflective area of the first outer surface is larger than a visible reflective area of the second outer surface.

10. The side mirror assembly of claim 9, wherein the second outer surface of the secondary mirror is offset a distance behind the first inner surface of the primary mirror.

11. The side mirror assembly of claim 10, wherein the support is a first support, and further comprising a second support extending between the primary mirror and the secondary mirror and coupled to the primary mirror and the secondary mirror.

12. The side mirror assembly of claim 9, wherein the support is fixedly coupled to both the primary mirror and the secondary mirror such that relative movement between the primary mirror and the secondary mirror is prevented.

13. The side mirror assembly of claim 12, further comprising a backer extending along the first inner surface and the second inner surface, wherein the backer fixedly couples the primary mirror and the secondary mirror to the support.

14. The side mirror assembly of claim 13, wherein the backer includes a heating element configured to provide thermal energy to at least one of the primary mirror and the secondary mirror.

15. The side mirror assembly of claim 9, wherein the first outer surface of the primary mirror has a first curvature, wherein the second outer surface of the secondary mirror has a second curvature, and wherein the first curvature is different from the second curvature.

16. The side mirror assembly of claim 9, wherein the primary mirror and the secondary mirror are fixed relative to the support such that a movement of the support causes a corresponding movement of both the primary mirror and the secondary mirror.

17. A mirror system for a side mirror of a vehicle, comprising:
a support configured to be movably coupled to a housing of the side mirror;
a primary mirror having a first outer surface disposed at a first angle relative to a user and a first inner surface opposite the first outer surface and coupled to the support, wherein the primary mirror is reflective and provides a first field of view; and
a secondary mirror having a second outer surface disposed at a second angle relative to the user and a second inner surface opposite the first outer surface and coupled to the support, wherein the secondary mirror is reflective and provides a second field of view different from the first field of view;
wherein the primary mirror and the secondary mirror are arranged such that the primary mirror is at least partially superimposed on the secondary mirror, thereby defining an overlapped area of the second outer surface, and wherein a visible reflective area of the first outer surface is larger than a visible reflective area of the second outer surface.

18. The mirror system of claim 17, wherein the support is a first support, and further comprising a second support extending between the primary mirror and the secondary mirror and coupled to the primary mirror and the secondary mirror.

19. The mirror system of claim 18, wherein the second outer surface of the secondary mirror is offset a distance from the first inner surface of the primary mirror, and wherein the second support extends between the primary mirror and the secondary mirror adjacent the overlapped area.

20. The mirror system of claim 19, further comprising a backer extending along the first inner surface and the second inner surface, wherein the backer fixedly couples the primary mirror and the secondary mirror to the first support.
